(19) United States
(12) Patent Application Publication
(10) Pub. No.: US 2008/0133197 A1
(43) Pub. Date: Jun. 5, 2008

(54) LAYOUT METHOD FOR PROTEIN-PROTEIN INTERACTION NETWORKS BASED ON SEED PROTEIN

(75) Inventors: Sun-Lee Bang, Daejon (KR); Jae-Hun Choi, Daejon (KR); Jong-Min Park, Daejon (KR); Yong-Ho Lee, Seoul (KR); Soo-Jun Park, Seoul (KR); Seon-Hee Park, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-City (KR)

(21) Appl. No.: 11/932,880

(22) Filed: Oct. 31, 2007

(30) Foreign Application Priority Data
Dec. 4, 2006 (KR) 10-2006-0121688
Apr. 25, 2007 (KR) 10-2007-0040512

(51) Int. Cl. G06G 7/48

(52) U.S. Cl. 703/11

(57) ABSTRACT

Provided is a layout method for protein-protein interaction networks based on a seed protein, which is for performing multiple stages of nesting centered on a node having a high degree of physical relationship, and performing multiple stages of extension and force directed placement (FDP) with respect to a final nest graph. The layout method includes the steps of: a) extracting a node list of each sub-graph constituting a protein-protein interaction network, and aligning the node list according to adjacency of nodes; b) selecting a seed protein from the aligned node list according to node priority and nest relationship with another node; c) nesting adjacent nodes centered on the selected seed protein to generate a nested node; and d) selecting an initial position of the generated nested node, placing the nodes of the nested nodes on respective division points, centered on the seed protein, and then performing layout.

### CROSS-REFERENCE(S) TO RELATED APPLICATIONS

The present invention claims priority of Korean Patent Application Nos. 10-2006-0121688 and 10-2007-0040512, filed on Dec. 4, 2006, and Apr. 25, 2007, respectively, which are incorporated herein by reference.

### BACKGROUND OF THE INVENTION

1. Field of the Invention

The present invention relates to a layout method for protein-protein interaction networks based on a seed protein; and, more particularly, to a layout method for protein-protein interaction networks based on a seed protein, which performs multiple stages of nesting, centered on a node having a high degree of physical relationship, and performs multiple stages of extension and force directed placement (FDP) with respect to a final nest graph.

This work was supported by the Information Technology (IT) research and development program of the Korean Ministry of Information and Communication (MIC) and/or the Korean Institute for Information Technology Advancement (IITA) [2005-S-008-02, “SW Component Development of Bio Data Mining & Integrated Management”].

2. Description of Related Art

In general, one protein has its own function, but also interacts with various kinds of proteins in order to perform a specific biological function within a living organism. Within one cell, complicated interactive relationships exist between multiple proteins.

Currently, a protein-protein interaction network is being extracted fast through biological experiments called ‘Yeast Two-Hybrid’ and ‘co-AP/MS’, and representative extracted data are being systematically managed through a database such as a biomolecular interaction network database (BIND), a database of interacting protein (DIP), and ‘IntAct’.

The protein-protein interaction network can be expressed by representing each protein as a node and interaction between proteins as an edge in the interaction data between proteins. Research is being conducted on a network analysis application system in order to understand not just a specific protein but also the overall mechanism of the living organism from complicated relationships between massive proteins. There has been a progress in the research on a method of expressing massive data having relationships with each other in a graph to facilitate the understanding of the data, and this method is being widely used.

To lay out the protein-protein interaction network, a force-directed placement (FDP) algorithm is commonly used. The FDP algorithm assigns forces to a set of nodes and edges, and lays out the network in a balanced state. In order to prevent the edges from overlapping each other in the layout, an edge between connected nodes is considered a local force, which is a pulling force, and unconnected nodes are considered a global force, which is a pushing force.

The FDP algorithm is used because of its flexibility, easy implementation, and good drawing results, but has limitations in that it works slowly for massive data.

To solve this limitation, a multilevel for force-directed placement (MFDP) algorithm of ‘Walshaw’ has been developed, in which clusters are formed at multi stages, and the FDP algorithm is applied to a process of extending the clusters.

However, the MFDP algorithm has following limitations. Because a start node is randomly set at each stage, and a force between nodes of every pair must be calculated during a multiple cluster forming process, a quite long process time is required in the case where one node such as a hub node has a plurality of neighboring nodes.

### SUMMARY OF THE INVENTION

An embodiment of the present invention is directed to providing a layout method for protein-protein interaction networks based on a seed protein, which is for performing multiple stages of nesting centered on a node having a high degree of physical relationship, and performing multiple stages of extension and force directed placement (FDP) with respect to a final nest graph.

In accordance with an aspect of the present invention, there is provided a layout method for protein-protein interaction networks based on a seed protein, the method which includes the steps of: a) extracting a node list of each sub-graph constituting a protein-protein interaction network, and aligning the node list according to adjacency of nodes; b) selecting a seed protein from the aligned node list according to node priority and nest relationship with another node; c) nesting adjacent nodes centered on the selected seed protein to generate a nested node; and d) selecting an initial position of the generated nested node, placing the nodes of the nested nodes on respective division points, centered on the seed protein, and then performing layout.

In accordance with another aspect of the present invention, there is provided a layout method for protein-protein interaction networks based on a seed protein, which includes the steps of: a) extracting a node list of each sub-graph constituting a protein-protein interaction network and aligning the node list according to adjacency of nodes; b) selecting a seed protein from the aligned node list according to node priority and nesting relationship with another node; c) nesting adjacent nodes centered on the selected seed protein at multiple stages to generate a nested node; d) selecting an initial position of the generated nested node, positioning the nodes of the nested node on respective division points, centered on the corresponding seed protein, and then confirming a position of each of the nodes of the nested node; and e) setting a division point centered on a seed protein of a nested node among the position-confirmed nodes, setting a representative position, placing a divided node, and performing layout.

Further, a graph is laid out, centered on a protein having a high degree of physical relationship in a protein-protein interaction network by applying a spring-force layout technology at multiple stages, so that the protein-protein interaction network is expressed in a graph in a balanced state, and is laid out at a high speed.

Furthermore, multiple stages of nesting are performed centered on a node with a high degree of physical relationship, and then extension is performed in which a plurality of nodes of a nested node are evenly disposed. Accordingly, a force-directed placement (FDP) process is reduced, thereby improving a speed while achieving balanced layout.

Moreover, a start-node selection process, a nesting process, and an extension process of the MFDP algorithm of “Walshaw” are improved in order to express the protein-protein interaction network in a graph in a balanced state at a high speed.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a block diagram showing an apparatus for implementing a layout method for protein-protein interaction networks based on a seed protein in accordance with an embodiment of the present invention.

FIG. 2 is a flowchart describing a layout method for protein-protein interaction networks based on a seed protein in accordance with an embodiment of the present invention.

FIG. 3 is a flowchart describing a process of selecting nest nodes among adjacent nodes of a seed protein and nesting them in accordance with an embodiment of the present invention.

FIG. 4 illustrates a process of nesting nodes of a sub-graph in accordance with an embodiment of the present invention.

FIG. 5 explains a first extension process of a nested node in accordance with an embodiment of the present invention.

FIG. 6 illustrates a second extension process of a first-extended nested node in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. In some embodiments, well-known processes, well-known device structures, and well-known techniques will not be described in detail to avoid ambiguous interpretation of the present invention.

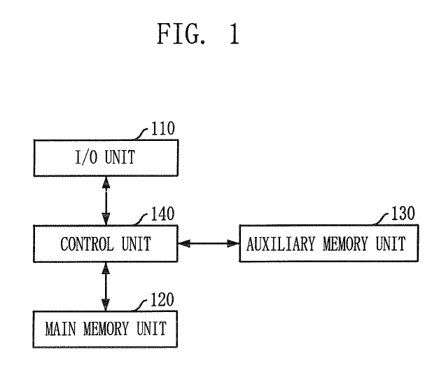

FIG. 1 is a block diagram of an apparatus for implementing a layout method for protein-protein interaction networks based on a seed protein in accordance with an embodiment of the present invention.

As shown in FIG. 1, an apparatus for implementing a layout method for a protein-protein interaction network based on a seed protein in accordance with an embodiment of the present invention includes an I/O (input/output) unit 110, a main memory unit 120, an auxiliary memory unit 130, and a control unit 140. The I/O unit 110 inputs/outputs protein-protein interaction data, laid-out protein-protein interaction networks, and change states of a sub-network, i.e., a sub-graph generated in the layout process. The main/auxiliary memory unit 120/130 stores protein interaction networks, layout results over multiple stages, data generated during various calculation processes, and protein-protein interaction data input through the I/O unit 110. The control unit 140 controls the main/auxiliary memory unit 120/130, and the I/O unit 110. Also, the control unit 140 performs multiple stages of nesting centered on a node with a high degree of physical relation ship, multiple stages of extension and force-directed placement (FDP) with respect to a final nest graph, thereby expressing the massive protein-protein interaction networks in a graph in a balanced stage, and laying out the graph at a high speed.

The control unit 140 may be implemented as a microprocessor. A program is loaded on the control unit 140. The program includes a layout method for a protein-protein interaction network based a seed protein in accordance with the present invention, which will be described later. Then, protein-protein interaction networks (data) are input to execute the program. Thereafter, the program can lay out protein-protein networks through various calculations.

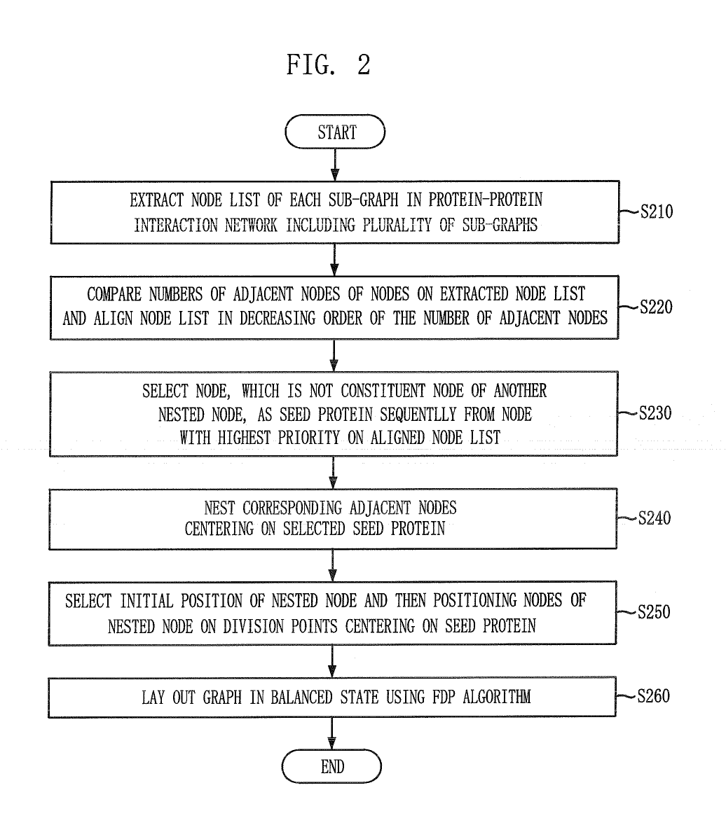

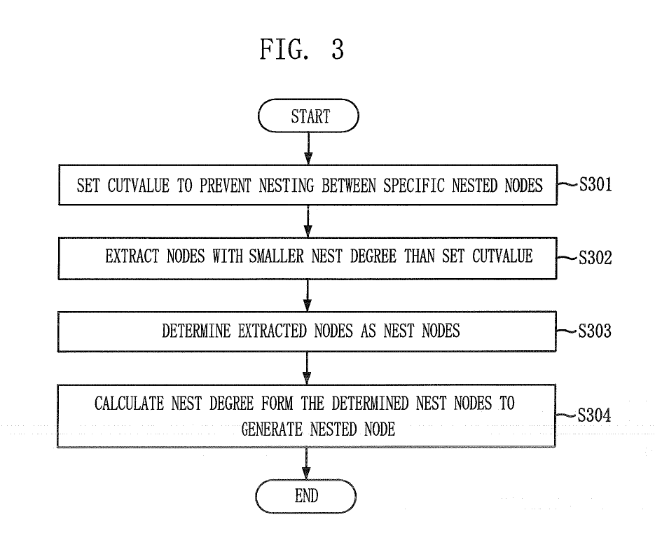

Hereinafter, main operations of a layout method for a protein-protein interaction network based on a seed protein in accordance with an embodiment of the present invention will now be described with reference to FIG. 2. Also, detailed operations and embodiments thereof will be described with reference to FIGS. 3 to 6.

FIG. 2 is a flowchart of a layout method for protein-protein interaction networks based on a seed protein in accordance with an embodiment of the present invention.

A protein-protein interaction network includes a plurality of sub-networks (hereinafter, referred to as “sub-graphs”). In step S210, a node list of each sub-graph is extracted from the protein-protein interaction network.

Thereafter, the extracted node list is aligned according to node adjacency. That is, in step S220, nodes are compared in terms of numbers of adjacent nodes, and are aligned in decreasing order of the number of adjacent nodes. If the nodes have the same number of adjacent nodes, those nodes are aligned in decreasing order of the number of nodes nested in the node (hereinafter, referred to as a nested degree). If the nested degrees are identical, the nodes are aligned randomly.

Thereafter, a seed protein is selected from the aligned node list according to node priority and nesting relationships with another node. That is, in step S230, a node, which is not a constituent node of another nested node, is selected as a seed protein sequentially from a node having the highest priority on the aligned node list.

In step S240, corresponding adjacent nodes are nested centered on the selected seed protein.

Thereafter, in step S250, an initial position of the nested node is selected, and then nodes of the nested node are placed on division points, centered on the corresponding seed protein.

In step S260, a graph is laid out in a balanced state by using an FDP algorithm.

FIG. 3 is a flowchart of a process of selecting nesting target nodes (hereinafter, referred to as nest nodes) among adjacent nodes of a seed protein, and performing nesting thereof in accordance with an embodiment of the present invention.

In step S301, a cutvalue is set so as to prevent nesting between specific nested nodes. That is, nodes on a node list are aligned in decreasing order of the number of nest nodes (hereinafter, referred to as a nest degree) of each node, and then a cutvalue is set to the minimum nest degree among nest degrees that belong to, e.g., top 20% of the nest degrees and are greater than a mean value of the nest degrees of the nodes.

In step S302, nodes having a smaller nest degree than the set cutvalue are extracted.

In step S303, the extracted nodes are determined as nest nodes.

In step S304, a nest degree is calculated from the determined nest nodes, thereby generating a nested node. Here, the nest degree is calculated, including a seed node, i.e., a protein that serves as the core of nesting.

The nesting between nodes may be performed only up to a specific value of an entire graph and a determined nesting stage.

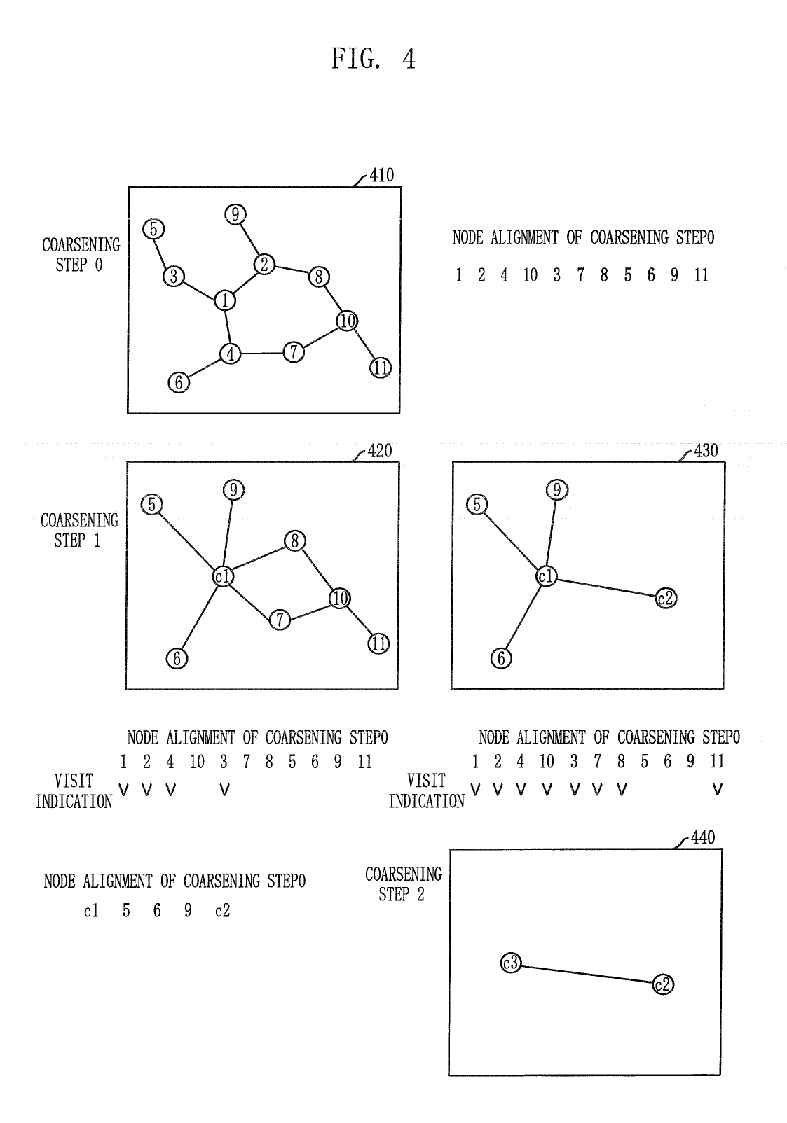

A process of extracting a node list of each sub-graph in the protein-protein interaction network and nesting nodes of the extracted node list will now be described in detail with reference to FIG. 4.

In FIG. 4, reference number 410 indicates one sub-graph of the protein-protein interaction network. In the sub-graph 410, a node list is extracted and nodes on the node list are aligned as follows: 1, 2, 4, 10, 3, 7, 8, 5, 6, 9, and 11.

In detail, according to a result of checking the number of adjacent nodes of each node, a node 1, a node 2, a node 4 and a node 10 each have three adjacent nodes, a node 3, a node 7 and a node 8 each have two adjacent nodes, and a node 5, a node 6, a node 9 and a node 11 each have one adjacent node. Also, each node is not a nested node.

Accordingly, the nodes are aligned in decreasing order of the number of adjacent nodes, and the nodes having the same number of adjacent nodes are aligned randomly.

Thereafter, the node 1 placed first on the aligned node list is selected as a seed protein, and is nested with it adjacent nodes. A result of this nesting is shown in a sub-graph 420 of FIG. 4. In detail, the node 1, the node 2, the node 3 and the node 4 are nested to generate a node c1. Here, the nested degree of the node c1 is four.

Then, although the next node on the aligned node list is the node 2, the node 2 has already been nested as the adjacent node of the node 1 and so has the node 4, the next seed protein becomes the node 10.

Thus, after the node 10 is selected as a seed protein, the node 10 is nested with its adjacent nodes, i.e., the node 7, the node 8 and the node 11, thereby generating a node c2. A result of this nesting is shown in a sub-graph 430 of FIG. 4. Here, the nested degree of the node c2 is four.

Thereafter, the next seed protein is the node 5, and its adjacent node is the node c1, which is a nested node.

Accordingly, a cutvalue is calculated in order to determine whether the node c1 can be a nest node. The cutvalue may be previously obtained during a node list extracting process.

A cutvalue generating process will now be described. In the case where the nodes on the aligned node list are nested, the respective nest degrees (the number of adjacent nodes+itself 1) of the node 1, the node 2, the node 4, and the node 10 are four, the nest degrees of the node 3, the node 7 and the node 8 are three, and the nest degrees of the node 5, the node 6, the node 9 and the node 11 are two.

For example, a nest degree belonging to top 20% of the nest degrees is four, and the mean value of the nest degrees of the nodes is three.

Accordingly, the minimum nest degree among nest degrees that belong to, e.g., top 20% and are greater than three, which is the mean value of the nest degrees, is four. Thus, the cutvalue is set to four.

Since the nested degree of the node c1 is four, which is identical to the cutvalue 4, the node c1 cannot be a nest node.

Thus, there is no node to be nested with the node 5.

Likewise, the node 6 and the node 9 do not have nodes to be nested with.

After every node is visited once, newly generated nested nodes are substituted for old ones, thereby generating a new node list. The alignment condition is as mentioned above.

That is, the node c1 having the largest number of adjacent nodes is aligned first, and the node 5, the node 6, the node 9 and the node c2 having the same number of adjacent nodes are aligned in decreasing order of nested degree.

Accordingly, the node c2 having the nested degree of 4 is aligned last. Since the node 5, the node 6, and the node 9 are not nested, those nodes are aligned randomly.

Thereafter, the node c1, which is the first node on the newly aligned node list, is selected as a seed protein, and then the node 5, the node 6 and the node 9 are nested therewith to generate a node c3. The final sub-graph is as shown in a sub-graph 440 of FIG. 4.

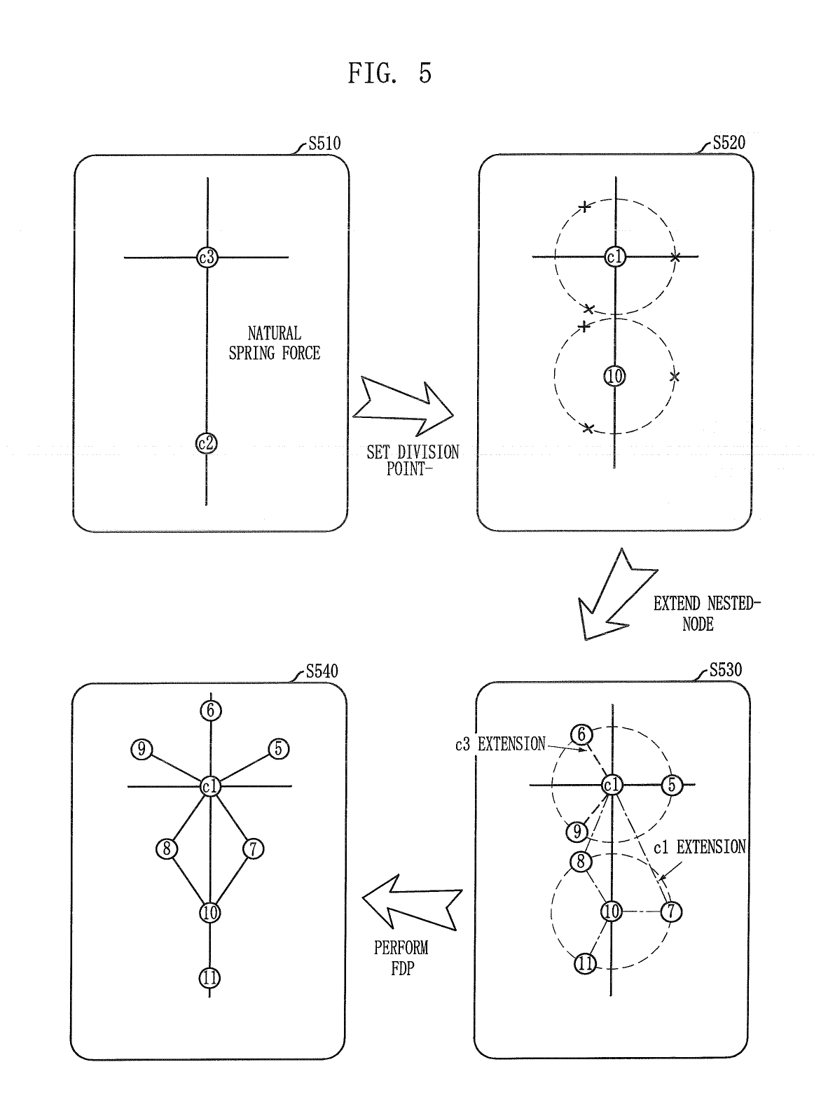

FIG. 5 is a view for explaining a first extension process of a nested node in accordance with an embodiment of the present invention.

In step S510, initial positions of a nested node c3 and a nested node c2 are selected through a well known “natural spring force” algorithm.

Thereafter, division points for evenly arranging nodes nested centered on a seed protein of each of the nested nodes c3 and c2 are selected.

That is, in step S520, for each of the nested nodes c3 and c2, the division points as many as the nested degree of the corresponding nested node are evenly set on a circle having “spring force” as a radius. A node selected as the seed protein at the time of generation of the corresponding nested node is placed at the center of the circle.

In step S530, the nodes of each of the nested nodes c3 and c2 are sequentially placed at the division points. Since the nested nodes 5, 6 and 9 are not related to nodes whose positions are confirmed, the nodes 5, 6 and 9 are sequentially placed at the respective division points.

In step S540, a position of each node is set on the division point through the FDP algorithm, thereby completing the first extension process of the nested nodes c3 and c2.

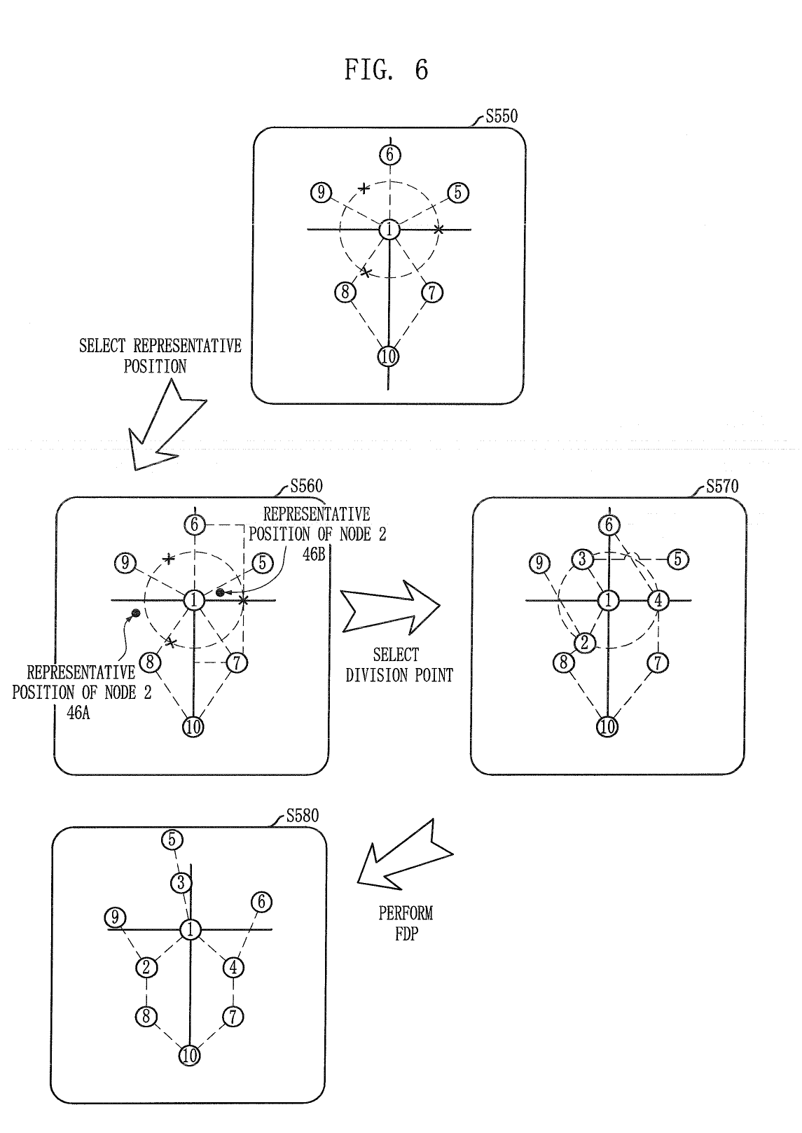

A second extension process of a nested node having completed the first extension process will now be described with reference to FIG. 6.

In step S550, respective division points of the nodes 2, 3 and 4 of the nested node c1 are set centered on the node 1, which is a seed protein of the nested node c1.

As shown in the sub-graph 410 of FIG. 4, the node 2 is related to the nodes 8 and 9, and the node 4 is related to the nodes 6 and 7.

In step 560, a middle point 46A between xy coordinates of the node 8 and node 9 are set to a representative position of the node 2, and a middle point 46B between xy coordinates of the node 6 and node 7 is set to a representative position of the node 4.

In step S560, a corresponding node is placed at a division point set on the same quadrant as the representative position of the corresponding node, and nodes that do not have respective representative positions are placed at empty division points.

In step S580, the FDP algorithm is performed, thereby finally laying out a graph in a balanced state.

Results of comparing the layout method for a protein-protein interaction network based on a seed protein with the MFDP algorithm of “Walshaw” are as shown in Table 1 below.

TABLE 1

| | Network | | | |
|---|---|---|---|---|
| | size | Placement time (ms) | | (%) |
| | Node/ | | Hub-Seeded | Improvement |
| Species | Edge | MFDP | MFDP | rate |
| Yeast | 4534/16383 | 363750 | 294687 | 19 |
| C. elegans | 2353/3334 | 118766 | 44172 | 63 |
| E. Coli | 1833/6948 | 48156 | 30109 | 37 |
| D. melanogater | 887/1116 | 19516 | 8469 | 57 |
| Homo Sapiens | 846/1012 | 3875 | 2328 | 40 |

As shown in Table 1, the layout speed in accordance with an embodiment of the present invention is improved by maximum 63%. This means that the massive protein-protein interaction networks can be laid out at a high speed by using information of nodes having high degrees of physical relationship.

In accordance with the present invention, nesting is performed at multiple stages, centered on a node with a high degree of physical relationship, and expansion and FDP are performed at multiple stages for the final nesting graph. Accordingly, mass protein-protein interaction networks can be expressed in a graph in a balanced state, and thus be laid out at a high speed.

The methods in accordance with the embodiments of the present invention can be realized as programs and stored in a computer-readable recording medium that can execute the programs. Examples of the computer-readable recording medium include CD-ROM, RAM, ROM, floppy disks, hard disks, magneto-optical disks and the like.

While the present invention has been described with respect to the specific embodiments, it will be apparent to those skilled in the art that various changes and modifications may be made without departing from the spirit and scope of the invention as defined in the following claims.

What is claimed is:

1. A layout method for protein-protein interaction networks based on a seed protein, the method comprising the steps of:
a) extracting a node list of each sub-graph constituting a protein-protein interaction network, and aligning the node list according to adjacency of nodes;
b) selecting a seed protein from the aligned node list according to node priority and nest relationship with another node;
c) nesting adjacent nodes centered on the selected seed protein to generate a nested node; and
d) selecting an initial position of the generated nested node, placing the nodes of the nested nodes on respective division points, centered on the seed protein, and then performing layout.

2. The method of claim 1, wherein the step d) includes the steps of:
d1) selecting an initial position of the generated nested node;
d2) selecting division points for evenly arranging the nodes that is nested centered on the seed protein of the nested node;
d3) sequentially pacing the nodes of the nested node at the respective set division points; and
d4) confirming a position of each node on the division point to layout a graph in a balanced state.

3. The method of claim 2, wherein the step d1) is performed using a natural spring force algorithm.

4. The method of claim 2, wherein the step d4) is performed using a force-directed placement (FDP) algorithm.

5. The method of claim 1, wherein the step c) includes the steps of:
c1) setting a cutvalue for node nesting;
c2) extracting nodes having nest degrees smaller than the set cutvalue;
c3) selecting the extracted nodes as nest nodes; and
c4) calculating a nest degree from the selected nest nodes to generate a nested node.

6. The method of claim 1, wherein the step b) includes the steps of:
b1) selecting a node which is not a constituent node of another nested node, as the seed protein sequentially from a node with the highest priority on the aligned node list; and
b2) nesting corresponding adjacent nodes, centered on the selected seed protein.

7. The method of claim 1, wherein the step a) includes the steps of:
a1) extracting a node list of each sub-graph from the protein-protein interaction network including a plurality of sub-networks; and
a2) comparing numbers of adjacent nodes of the nodes on the extracted list, and aligning the nodes in decreasing order of the number of adjacent nodes.

8. The method of claim 7, wherein, in the step a), the nodes on the node list having the same number of adjacent nodes are aligned randomly.

9. A layout method for protein-protein interaction networks based on a seed protein, comprising the steps of:
a) extracting a node list of each sub-graph constituting a protein-protein interaction network and aligning the node list according to adjacency of nodes;
b) selecting a seed protein from the aligned node list according to node priority and nesting relationship with another node;
c) nesting adjacent nodes centered on the selected seed protein at multiple stages to generate a nested node;
d) selecting an initial position of the generated nested node, positioning the nodes of the nested node on respective division points, centered on the corresponding seed protein, and then confirming a position of each of the nodes of the nested node; and
e) setting a division point centered on a seed protein of a nested node among the position-confirmed nodes, setting a representative position, placing a divided node, and performing layout.

10. The method of claim 9, wherein the step e) includes the steps of:
e1) setting a division point centered on a seed protein of a nested node among the position-confirmed nodes;
e2) determining a middle point between a node of the nodded node and the position-confirmed node as a representative position; and
e3) placing the corresponding node at a division point set on the same quadrant as the representative position of the corresponding node, placing nodes without representative positions at respective empty division points, and laying out a graph in a balanced state.

11. The method of claim 9, wherein the step c) includes the steps of:
c1) when the seed protein includes a nested node as the adjacent node in the case of multi-stage nested node generation, comparing a nested degree of the nested node with a cutvalue to determine whether the nested node is a nest node;
c2) determining the nested node as a nest node when the nested degree is smaller than the cut value; and
c3) not determining the nested node as the nest node when the nested degree is equal to or greater than the cutvalue.

12. The method of claim 11, wherein the step c) further includes the steps of:
c4) visiting all of nodes on the aligned node list once, and substituting the nodes with newly generated nested nodes to generate a new node list; and
c5) aligning the generated new node list.

13. The method of claim 12, wherein, in the step c5), nodes are aligned in decreasing order of the number of adjacent nodes on the node list, and the nodes are aligned in decreasing order of nested degree of each node when the nodes have the same number of adjacent nodes.

14. The method of claim 11, wherein the cutvalue is a minimum nest degree among nest degrees that belong to top 20% of nest degrees of the respective nodes on the aligned node list and that are greater than a mean value of the nest degrees of the nodes, the nest degree being defined by [1+(the number of adjacent node)].

15. The method of claim 9, wherein the step d) uses a force-directed placement (FDP) algorithm to confirm the position of each node of the nested node.

16. The method of claim 9, wherein the step b) includes the steps of:
b1) selecting a node, which is not a constituent node of another nested node, as a seed protein sequentially from a node with the highest priority node on the aligned node list; and
b2) nesting corresponding adjacent nodes, centered on the selected seed protein.

17. The method of claim 9, wherein the step a) includes the steps of:
a1) extracting a node list of each sub-graph from the protein-protein interaction network including a plurality of sub-graphs; and
a2) comparing numbers of adjacent nodes of nodes on the extracted node list, and aligning the nodes in decreasing order of the number of adjacent nodes.

18. The method of claim 17, wherein in the step a), the nodes with the same number of adjacent nodes are randomly aligned on the node list.
